(19) United States
(12) Patent Application Publication
(10) Pub. No.: US 2010/0086289 A1
(43) Pub. Date: Apr. 8, 2010

(54) MODULAR TANKLESS WATER HEATER WITH PRECISE POWER CONTROL CIRCUITRY AND STRUCTURE

(76) Inventors: Gregg C. Johnson, Chandler, AZ (US); Stephen D. Neale, Phoenix, AZ (US); Scott A. Holland, Tempe, AZ (US)

Correspondence Address: ROBERT A. PARSONS, 4000 N. CENTRAL AVENUE, SUITE 1220, PHOENIX, AZ, 85012, US

(21) Appl. No.: 12/553,244

(22) Filed: Sep. 3, 2009

Related U.S. Application Data
(60) Provisional application No. 61/093,861, filed on Sep. 3, 2008.

(51) Int. Cl. F24H 1/10; H05B 3/02

(52) U.S. Cl. 392/490; 219/482

(57) ABSTRACT

Modular tankless water heater apparatus designed for use in a system including a water supply conduit and a hot water conduit. The apparatus includes a heating tube assembly with a plurality of tubes positioned in parallel juxtaposition and connected adjacent the ends into a series connected configuration to form a continuous fluid passage. A heating element is enclosed in each tube and extends between the ends with each heating element including an electrical connector and an electrical control. A programmable electrical power controller is connected to the electrical controls of the heating elements and to flow sensor and heat sensor apparatus positioned in the continuous fluid passage. The controller is programmed to activate the electrical controls one at a time in response to a demand signal from the flow sensor and heat sensor apparatus.

### CROSS-REFERENCE TO RELATED APPLICATIONS

This application claims the benefit of U.S. Provisional Application No. 61/093,861, filed 3 Sep. 2008. The entire disclosure of which is hereby incorporated by reference, including the drawings.

### FIELD OF THE INVENTION

This invention relates to tankless water heater controls and to tankless water heater structure.

More particularly, the present invention relates to power control of water heaters employing resistive heating elements and to improved structure.

### BACKGROUND OF THE INVENTION

The need for heated fluids, and in particular heated water, has long been recognized. Conventionally, water has been heated by electric heating elements or with oil or gas burners, while stored in a tank or reservoir. While conventional systems are effective, energy efficiency and water conservation can be poor. As an example, water stored in a hot water tank is maintained at a desired temperature at all times. Thus, unless the tank is well insulated, heat loss through radiation can occur, requiring additional input of energy to maintain the desired temperature. In effect, continual heating of the stored water is required. Additionally, the tank is often positioned at a distance from the point of use, such as the hot water outlet. In order to obtain the desired temperature water, cooled water in the conduits connecting the point of use (outlet) and the hot water tank must be purged before the hot water from the tank reaches the outlet. This can often amount to a substantial volume of water.

Many of these problems have been overcome by the use of tankless water heaters. However, heating water to a desired setpoint temperature accurately and efficiently in a consistent and safe manner can be problematic with current tankless systems. It is, for example, difficult and highly inefficient to heat water to a desired useable state each time hot water is used. Applying full power to heating elements for short periods and randomly is very fatiguing on components and causes substantial wear and degradation. Further, in many prior art types of water heaters the water is overheated, too much water is heated, or the water is heated above a maximum desired temperature, all of which wastes power and adds to the eventual deterioration of the system.

The flow of fluid in the most advanced prior art tankless systems, which is generally determined by current usage, is measured by a flow sensor. Thereafter the incoming fluid temperature is determined by a temperature sensing device (e.g. thermistor), in communication with the fluid. The inlet flow and incoming temperature of the water is then used by a microcontroller to calculate the amount of power required to heat the instantaneous flow of fluid to a preset setpoint temperature. The shortcoming of this traditional system is that it uses a preset equation (Watts=147.2×GPM×ΔT° F.) to calculate the amount of power needed, but relies on an assumption that a static voltage is available to be applied. In actual fact, the available voltage changes throughout the day and is typically different in most every physical location, varying by overall grid and local power loads, as well as local and grid infrastructure. Because the resistance changes in the heating element as the element heats (and goes through a duty cycle) and because each element differs as between each element due to duty cycle and manufacturing tolerances of each element, the actual power delivered by the system to heat water can deviate significantly from calculated power. This results in imprecise temperature control.

Typically, solenoid valves employed in water heater applications are normally open or normally closed. Therefore in order to change their normal state (e.g. normally closed to open) the solenoid must be powered to achieve and hold the changed state. In most water heating devices a normally closed solenoid is used. In operation, the normally closed solenoid is powered open and the solenoid consumes up to 12 watts of power continuously to permit the passage of water. When power is then removed, as a result of a leak or other pre-set triggering event, the solenoid closes. In this application a significant amount of energy is consumed over time to provide this functionality.

It would be highly advantageous, therefore, to remedy the foregoing and other deficiencies inherent in the prior art.

Accordingly, it is an object the present invention to provide new and improved power control circuitry and an improved structure for tankless water heaters.

### SUMMARY OF THE INVENTION

Briefly, to achieve the desired objects of the instant invention in accordance with a preferred embodiment thereof, a modular tankless water heater apparatus is designed for use in a system including a cold water supply conduit and a hot water conduit. The apparatus includes a heating tube assembly with a plurality of tubes positioned in parallel juxtaposition and connected adjacent the ends into a series connected configuration to form a continuous fluid passage. A heating element is enclosed in each tube and extends between the ends with each heating element including an electrical connector and an electrical control. A programmable electrical power controller is connected to the electrical controls of the heating elements and to flow sensor and heat sensor apparatus positioned in the continuous fluid passage. The controller is programmed to activate the electrical controls one at a time in response to a demand signal from the flow sensor and/or heat sensor apparatus.

The desired objects of the instant invention are further realized in accordance with a specific embodiment of modular tankless water heater apparatus for use in a system including a water supply conduit and a hot water conduit. The apparatus includes a heating tube assembly with a plurality of elongated stainless steel tubes positioned in parallel juxtaposition. The plurality of elongated tubes are fluid connected adjacent the ends into a series connected configuration to form a continuous fluid passage through each tube of the plurality of tubes in turn. The continuous fluid passage is adapted to be fluid coupled between the water supply conduit and the hot water conduit of the system. The fluid coupling between the water supply coupling and the continuous fluid passage defines a cold water end of the continuous fluid passage. A plurality of elongated heating elements one each is enclosed within each of the tubes of the plurality of tubes and extends substantially from one end to another of the enclosing tube. Each of the heating elements includes an electrical connector and an associated solid state relay switch or TRIAC. A heat sink is thermally attached to the cold water end of the continuous fluid passage and has the solid state relay switches mounted in heat exchanging position thereon. A programmable electrical power controller is connected to the electrical controls of the plurality of heating elements and to flow sensor and heat sensor apparatus positioned in the continuous fluid passage. The controller is programmed to activate the electrical controls one at a time in response to a demand signal from the flow sensor and/or heat sensor apparatus.

The desired objects of the instant invention are further realized in accordance with a specific embodiment of modular tankless water heater apparatus for use in a system including a water supply conduit and a hot water conduit. The apparatus includes a heating tube assembly with a plurality of elongated tubes positioned in parallel juxtaposition, the plurality of elongated tubes are fluid connected adjacent the ends into a series connected configuration to form a continuous fluid passage through each tube of the plurality of tubes in turn. The continuous fluid passage is adapted to be fluid coupled between the water supply conduit and the hot water conduit of the system. A plurality of elongated heating elements one each is enclosed within each of the tubes of the plurality of tubes and extends substantially from one end to another of the enclosing tube. Each of the heating elements includes an electrical connector with an electrical control. A programmable electrical power controller is connected to the electrical controls of the plurality of heating elements and to flow sensor and heat sensor apparatus positioned in the continuous fluid passage. The controller is programmed to activate the electrical controls one at a time in response to a demand signal from the flow sensor and/or heat sensor apparatus. The programmable electrical power controller is programmed with a startup delay. The startup delay prevents the activation of any of the electrical controls when water is drawn for a time period less than the startup delay.

### BRIEF DESCRIPTION OF THE DRAWINGS

The foregoing and further and more specific objects and advantages of the invention will become readily apparent to those skilled in the art from the following detailed description of a preferred embodiment thereof, taken in conjunction with the drawings in which:

FIG. 1 is a perspective view of the tankless water heater system in accordance with the present invention;

FIG. 2 is a perspective view of the tankless water heater system with the cover removed;

FIG. 3 is a perspective view of a heating tube assembly used in the present invention;

FIG. 4 is a block/schematic representation of water heater control circuitry coupled to a tankless water heater system;

FIG. 5 is a perspective view of a heat sink used in conjunction with the serpentine heating tubes of FIG. 3;

FIG. 6 is an end view of the heat sink of FIG. 5;

FIG. 7 is a pin diagram of a controller used in the preferred embodiment;

FIG. 8 is a pin diagram of a flow sensor used in conjunction with the controller of FIG. 7;

FIG. 9 is a pin diagram of a shutoff valve used in conjunction with the controller of FIG. 7;

FIG. 10 is a pin diagram of a leak detector used in conjunction with the controller of FIG. 7;

FIG. 11 is a circuit diagram of an embodiment of a latching solenoid valve used in conjunction with a water heating system in accordance with the present invention;

FIG. 12 is a top plan view of an embodiment of another heating tube assembly in accordance with the present invention;

FIG. 13 is a side plan view of the heating tube assembly of FIG. 12;

FIG. 14 is a top perspective view of the heating tube assembly of FIG. 12;

FIG. 15 is a side perspective view of the heating tube assembly of FIG. 12; and

FIG. 16 is a side perspective view of the heating tube assembly of FIG. 12, portions thereof broken away to illustrate the internal construction.

### DETAILED DESCRIPTION OF A PREFERRED EMBODIMENT

The present power control system incorporates inlet and outlet temperature sensing devices, an electrical current measuring device, an electrical voltage measuring circuit and a fluid flow sensor to provide data to a microcontroller in the precise application of power to control the heating of fluid. For a complete description of the general operation and structure of a tankless water heater refer to U.S. Pat. No. 7,046,922, entitled MODULAR TANKLESS WATER HEATER, issued 16 May 2006, and incorporated herein by reference.

It will be understood that generally there are two types of tankless or point of use water heaters: one in which the water flows through a conduit that has heating elements positioned on the outer surface and a type commonly referred to as immersion heaters in which heaters are immersed directly in the water as it flows through a conduit. The present invention pertains primarily to immersion heaters.

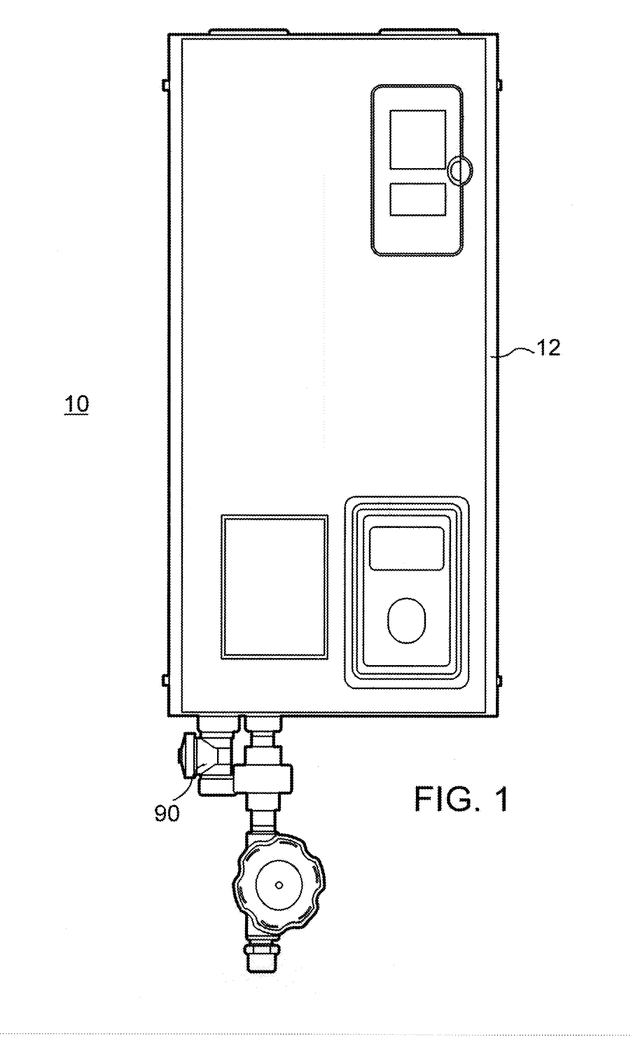

Generally, a point of use water heating system includes an inlet or water supply conduit, a water heating unit, and an outlet or hot water conduit. Water is supplied to the water heating unit through the water supply conduit, and hot water is dispensed from the water heating unit through the hot water conduit. In the present structure, a water heating unit 10 includes a chassis 12 carrying heating tube assembly 14 illustrated in FIGS. 1-3. Heating tube assembly 14 includes a plurality of heating tubes 16-19 extending between a lower end plate 20 and an upper end plate 22.

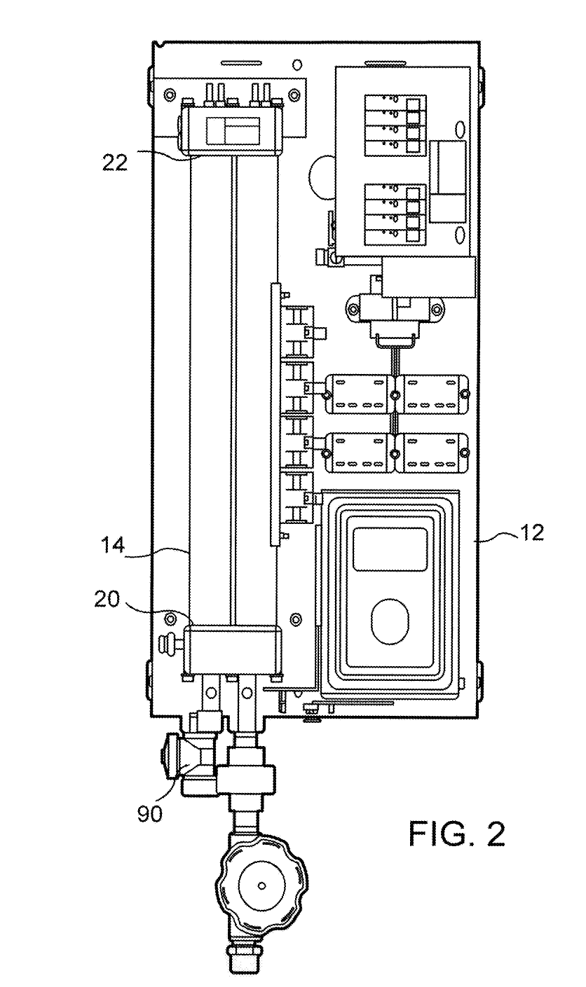

In previous systems, extruded aluminum chambers have been employed to convey heat from resistive heating areas to the fluid carried by Therein. In the specific embodiment illustrated in FIGS. 1-3, four tubes 16-19 are formed of stainless steel and held in a parallel spaced apart relationship, as illustrated in FIG. 3, by top and bottom end plates 20 and 22. The ends of heating tubes 16-19 are then fluid coupled together, as illustrated in FIG. 2, outside lower end plate 20 and an upper end plate 22 to form a continuous fluid path from a fluid inlet in one tube (e.g. tube 16) to a fluid outlet in a different tube (e.g. tube 19). By forming the heating tubes of stainless steel the likelihood of fluid corrosion is substantially reduced, due to the inherent resistance of stainless steel material to corrosion. Also, by mounting a plurality (four in this specific embodiment) of heating tubes in a compact serpentine unit, the cost of the device is substantially reduced. It will of course be understood that more or less tubes could be used in heating tube assembly 14 and four are illustrated for purposes of explanation.

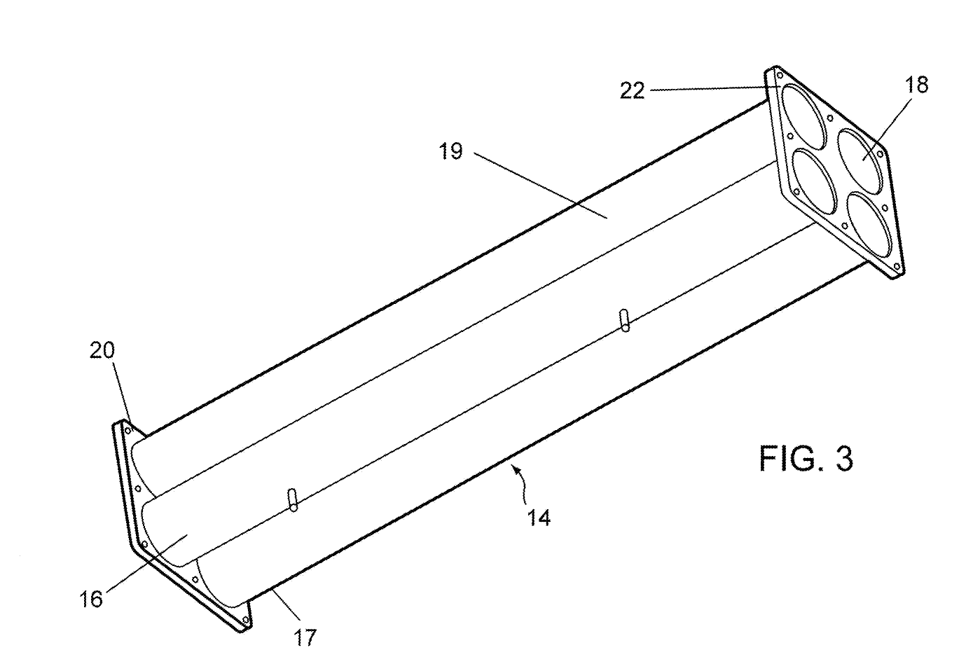

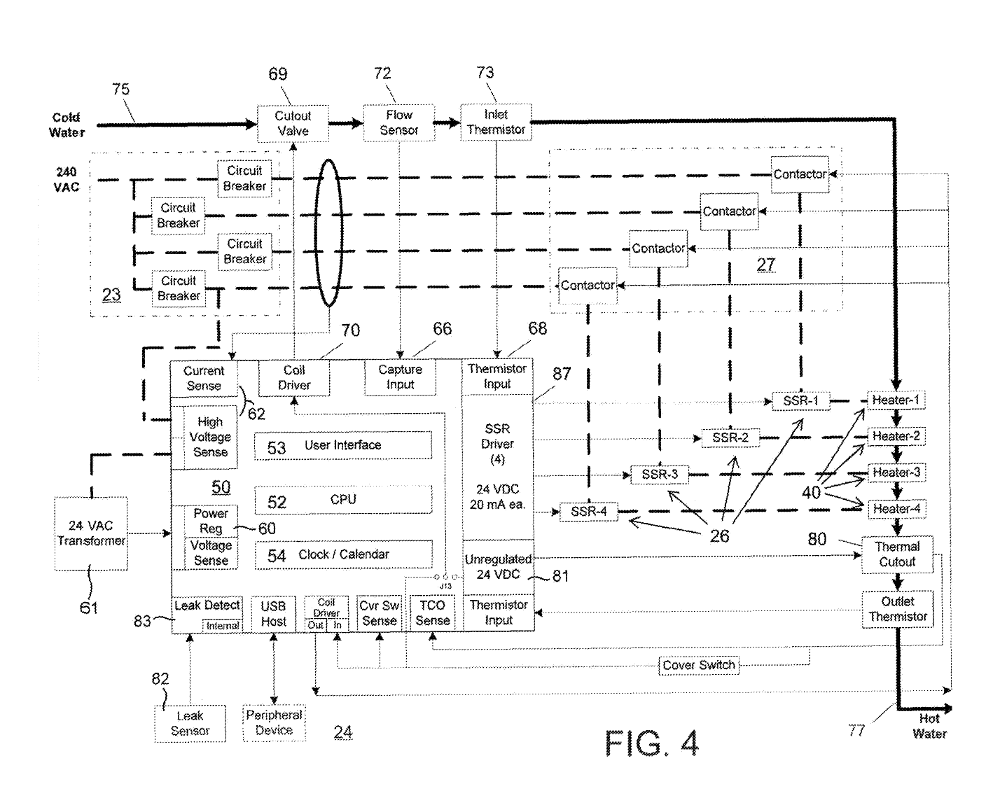

Turning now to FIG. 4, a block/schematic representation is illustrated of control circuitry 24 coupled to the tankless water heater system 10. Additional information on control circuit 24 and the associated system can be found in U.S. Pat. No. 7,164,851, entitled MODULAR TANKLESS WATER HEATER CONTROL CIRCUITRY AND METHOD OF OPERATION, issued 16 Jan. 2007, and incorporated herein by reference. Control circuitry 24 includes power module 23, mechanical relays 27, electrical components including solid state relays 26, heating elements 40, and a controller 50, as well as all of the sensing and other control components. Controller 50 includes a central processing unit (CPU) 52, a user interface 53 that allows some control of the various functions, a clock/calendar 54 for various timing requirements, and all of the sensing and driver circuits that perform the various functions and provide the data for determining whether functions need to be performed and/or are completed. Controller 50 provides the major control for operation of the control circuitry and is programmed, by means of programs stored in internal memory in a well known fashion, to perform the various functions described in more detail below.

Some of the sensing and driver circuits that are in or associated with controller 50 include a power regulator and voltage sensor 60 that is connected through a 24 volt transformer 61 and an energy measurement IC 62 to load center 23, a capture input 66 that receives signals from flow sensor 72, and a temperature control input 68 that receives inlet temperature from inlet temperature sensor 73. Flow sensor 72, and inlet temperature sensor 73 are all serially connected into cold water inlet line 75 in series with heaters 40a through 40d. Generally, the heating cycle is triggered by a signal from or activation of flow sensor 72. Temperature sensor 73 provides a signal to CPU 52 which calculates required power or temperature change ΔT in accordance with the flow and the incoming water temperature. Also, optionally, serially connected in cold water inlet line 75 is a cutout valve 69 that is controlled and driven by a coil driver 70 illustrated as a portion of controller 50. A thermal cutout switch 80 is serially connected in the hot water outlet line 77 (also in series with heaters 40a through 40d) and is fed by a 24 VDC unregulated power source 81 illustrated as a portion of controller 50.

Controller 50 further includes four drivers, designated 87, electrically connected to switching devices, which may be solid-state relay switches 26a, 26b, 26c, and 26d, TRIACs, or other switching devices. In this embodiment each of the four drivers 87 is a 24 volt DC 20 mA driver controlled by CPU 52. To ensure the correct heat for the most efficient power usage, when a heating cycle begins, a single one of heating elements 40 is brought on initially, followed by another and another until all of the heaters are on.

Also, programmed into CPU 52 for the operation of mechanical relays 27a, 27b, 27c, and 27d, solid-state relay switches 26a, 26b, 26c, and 26d and associated heating elements 40a, 40b, 40c, and 40d is an automatic channel or heating element test that is performed during the application of power and that provides detailed information about each of the channels, including the heaters. This information provides the ability to quickly and easily identify a failed, partially failed, or failing solid-state relay switch 26a, 26b, 26c, or 26d, as well as a failed, partially failed, or failing heating element 40a, 40b, 40c, or 40d, as well as a failed, partially failed, or failing mechanical relay 27a, 27b, 27c, or 27d, as well as a failed, partially failed, or failing circuit breaker 23a, 23b, 23c, or 23d. This test also allows the unit to be operated with a ‘missing channel’, which means that the unit is capable of heating water with less than all four elements in operation, allowing the consumer/owner to continue using hot water while a repair strategy is being developed.

Additionally, CPU 52 is programmed to perform a residual electrical current test each time water flow through the unit is stopped. The residual current test includes the option to perform a diagnostic evaluation of each channel. This diagnostic evaluation is performed anytime excessive current is detected after solid-state relay switchs 26a, 26b, 26c, and 26d have stopped firing.

A further feature programmed into CPU 52 is included as an energy saving feature. This feature includes a startup delay. The major purpose of the startup delay is to keep the unit from using energy during ‘short’ demands for water. In many instances a faucet is turned on and then off again within a relatively short time. These usages typically cause the unit to energize at least one solid-state relay switch 26a, 26b, 26c, or 26d and apply power to an associated heating element 40a, 40b, 40c, or 40d. During these ‘short’ time periods this power is wasted, because the heated water never reachs the faucet. This problem is substantially overcome by a startup delay that can be set, for example, in a range of one to thirty seconds, but can be longer or shorter as desired. If water is run for more than twice the delay period, the delay will not be applied to subsequent usages until after a reset time has elapsed. The reset time can be set in a range, for example, of zero to thirty minutes, but can be longer or shorter as desired.

As stated above, the available voltage changes throughout the day and is typically different in most every physical location, varying by overall grid and local power loads, as well as local and grid infrastructure. Also, because the resistance changes in the heating element as the element heats (and goes through a duty cycle) and because each element differs as between each other element due to duty cycle and manufacturing tolerances of each element, the actual power delivered by the system can deviate significantly from calculated power. To correct this deficiency, the preferred embodiment of the invention incorporates apparatus and a method to precisely measure the applied power under all voltage and load resistance conditions during the entire heating (duty) cycle. This is accomplished by simultaneously measuring the electrical current, via a current transformer, and applied voltage with an energy measurement IC, continuously during the heating cycle. The microcontroller (CPU 52) utilizes the input data, together with the basic power calculation described above, to create a precise applied power calculation. This applied power calculation is then used to compare against actual power applied during the prior heating period. The microcontroller then calculates the differential power application, or withdrawal of power, needed to make the combined two periods of power application very precise on a net basis of power (heat input). This methodology provides a more responsive and accurate control of fluid temperature in a dynamic situation than can be achieved by other devices utilizing an outlet temperature sensor for temperature (power) correction.

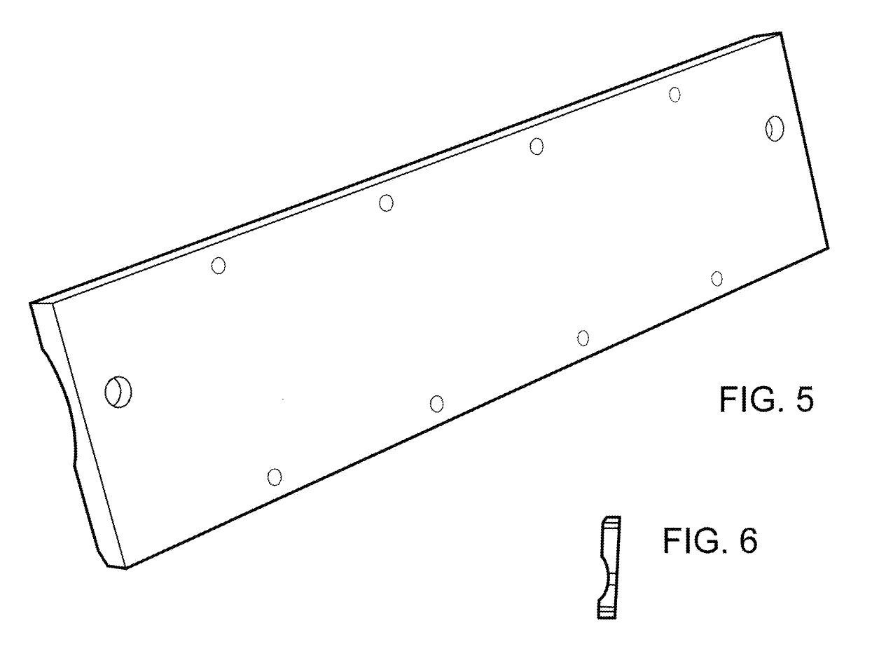

In the prior art tankless water heater system, the solid-state relay switches (e.g. SSR switches 26a, 26b, 26c, and 26d) were mounted on the aluminum extrusions forming the heating tubes. However, in the present structure the heating chamber is formed of stainless steel tubes. Referring additionally to FIGS. 5 and 6 a heat sink used in conjunction with the serpentine heating tubes of FIG. 3 is illustrated. In this preferred embodiment the heat sink is formed of a high heat conducting material, such as aluminum, and is formed to mate snuggly with at least one of the serpentine heating tubes and, preferably, one closer to the cold water inlet. The heat sink is fastened to the stainless steel heating chamber in such a way as to use the incoming cold water as a coolant for the solid-state relay switches. It is also possible to use well known thermal grease, for a temperature transfer between components. This adds to the overall energy efficiency of the unit as the waste heat from the solid-state relay switches is redirected back into the incoming water to be heated.

A drip/leak sensor 82, located below the water heater module, is connected to a leak detect input 83, illustrated as a portion of controller 50 in FIG. 4. If water is present, as sensed by drip/leak sensor 82, power to heaters 40 will be automatically removed by CPU 52. Also, a remote leak detector in a catch pan below the unit can be connected into the system. Such a catch pan arrangement is capable of detecting leaks from the heater and connecting fittings, etc. If an automatic cutout valve (e.g. cutout valve 69) is included in controller 50, the valve will be operated by CPU 52 to disrupt the incoming flow of cold water.

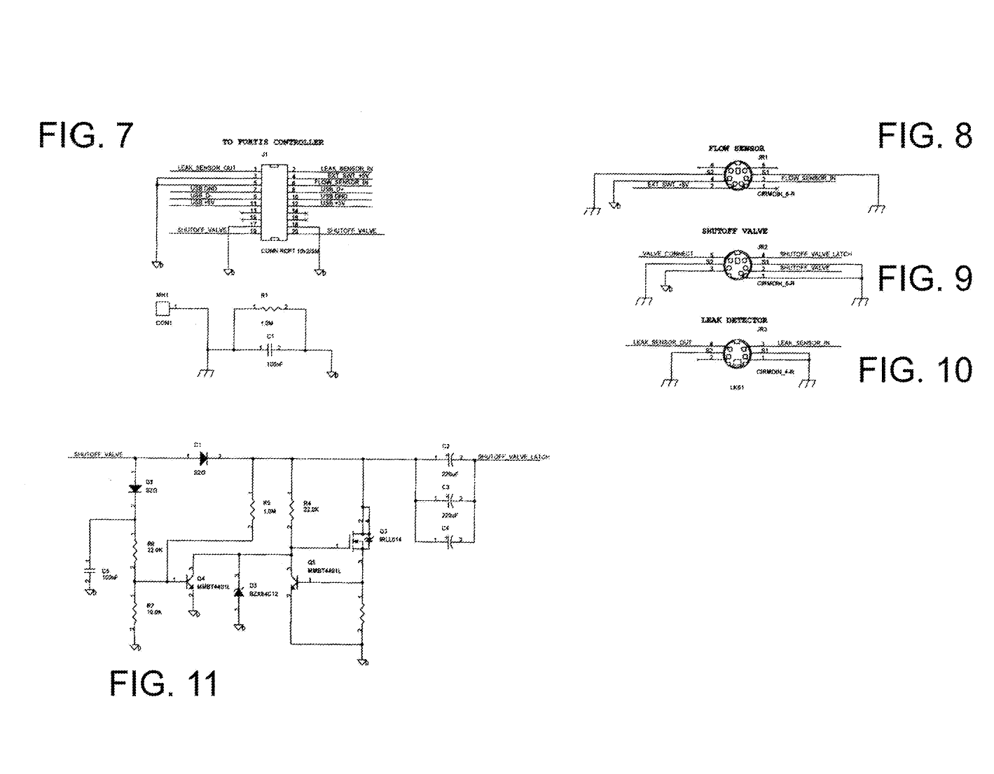

Referring to FIGS. 7-10, pin diagrams of a controller and a flow sensor, a shutoff valve, and a leak detector used in conjunction with the controller are illustrated. Referring additionally to FIG. 11 a circuit diagram is illustrated of an embodiment of a latching solenoid valve used in conjunction with a water heating system in accordance with the present invention. The embodiment of the latching solenoid valve acts as a water shut-off in the event a unit fluid leak is detected. The latching solenoid is servo assisted and does not draw any power to maintain its then current state of open or closed. Typically solenoid valves employed in fluid heating applications are normally open or normally closed, and a closed solenoid is normally used. The normally closed solenoid is powered open and consumes up to 12 watts of power continuously to permit the passage of water. When power is then removed as a result of a leak, the solenoid closes. In these prior art fluid heating applications a significant amount of energy is consumed over time to provide this functionality.

The latching solenoid, illustrated schematically in FIG. 11, consumes ZERO power to maintain its state, however, it requires power to change its state (in the present application that occurs in the event of a leak—or a manual input from a user requiring a change of state). The circuitry design provides the latching solenoid operation from a conventional non-latching solenoid control signal. This is accomplished by creating an activate pulse through the charging of a single capacitor thus changing the state of the latching solenoid. The removal of the solenoid signal results in the discharge of this capacitor which in turn reverses the then current state of the latching solenoid.

The preferred embodiment of the present water heating device has both internal and external (remote) leak detection. The leak detector sets off an audible and visible alarm, as well as triggering the latching solenoid valve to close and thus shut off the incoming water supply. The leak detector works with two sensors, an internal sensor located on the Interconnect board, and an externally sensor usually located in a pan or receptacle below the unit and the plumbing fittings. The leak detector sensors are aided in their functionality by the addition of Makrolon plastic shielding inside the heater that acts to both protect the microcontroller from water spray in the event of a catastrophic leak, as well as to direct any such water leakage directly to the sensor for faster leak detection.

The leak alarm once detected can be transmitted to a peripheral device via a USB port. The preferred embodiment of the present water heater includes the addition of such a USB Host port, as illustrated in FIG. 2, coupled to the microcontroller. This provides the ability to upload new firmware for the microcontroller; to add peripheral devices such as wireless communication devices and it also allows user access to data logs which include, but are not limited to operational usage data, operational errors, and usage statistics. The USB port, through the use of proprietary software, allows the water heater to communicate with other compatible devices so as to create a functional system power management regime for all compatible devices connected thereby reducing overall load conditions/usage.

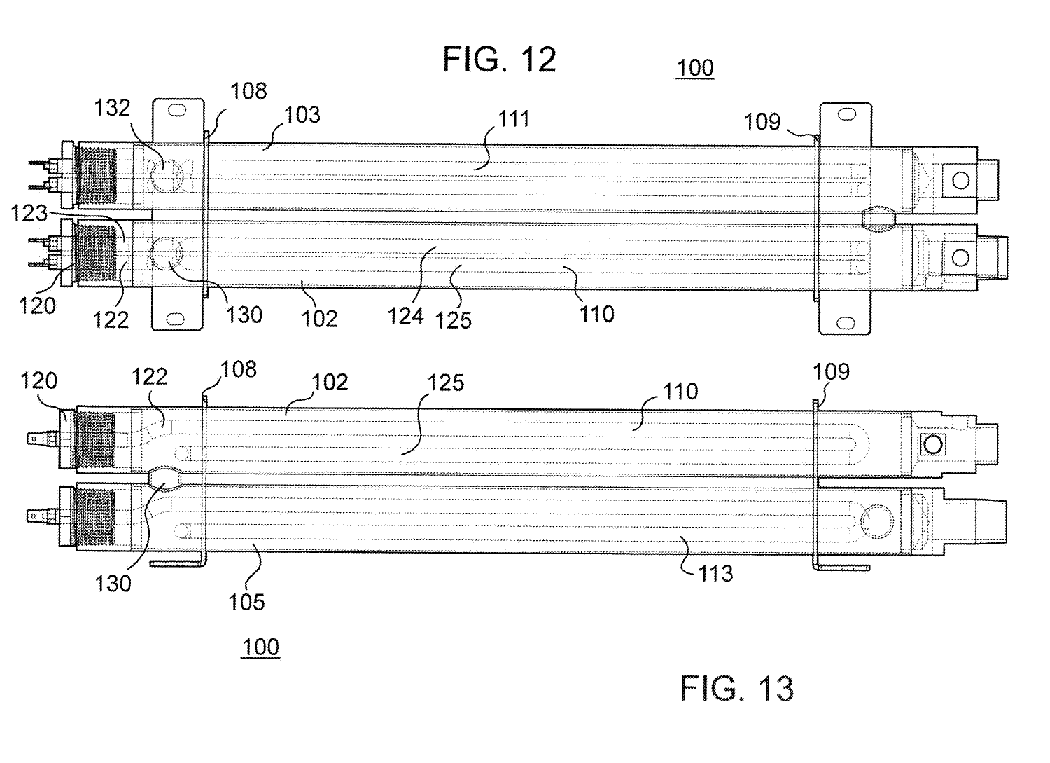

Turning now to FIGS. 12-16, another embodiment of a heating tube assembly 100 is illustrated in more detail. In this specific embodiment, assembly 100 includes four tubes 102, 103, 104, and 105 positioned in parallel and held in place by mounting brackets 107 and 109 adjacent opposite ends. Each of the tubes 102-105 has a heating element, designated 110, 111, 112, and 113, respectively, mounted therein. Because all of the heating elements are the same and are preferrably interchangeable, only element 110 will be discussed in detail.

Referring specifically to FIGS. 12 and 13, it can be seen that heating element 110 includes an electrical connector 120 threadedly engaged into one end of tube 102. Element 110 has four parallel oriented legs 122, 123, 124, and 125 extending substantially from one end of tube 102 to the other end. One end of leg 122 is connected to one contact of electrical connector 120 and one end of leg 123 is connected to the other contact of electrical connector 120. An opposite end of leg 122 is connected by a U-shaped end piece to a distal end of leg 125. An opposite end of leg 123 is connected by a U-shaped end piece to a distal end of leg 124. Proximal ends of legs 124 and 125 are connected together by a U-shaped end piece to form a complete electrical circuit between the two contacts of electrical connector 120 so as to be positioned in parallel juxtaposition in a folded orientation. In this embodiment, each of the heating elements 110, 111, 112, and 113 are formed stiff or rigid enough to be supported by electrical connector 120.

An inter-tube passageway 130 is provided between tubes 102 and 105 adjacent the ends having electrical connectors 120 positioned therein. Also, an inter-tube passageway 132 is provided between tubes 103 and 104 adjacent the ends having electrical connectors 120 positioned therein. The end of each tube 102, 103, 104, and 105 opposite electrical connector 120 is constructed to receive either a fluid coupling element 135 or a sealing element 137. Thus, for example, heating tube assembly 100 can be coupled so that fluid can be introduced or flow into fluid coupling element 135 at the end of tube 102 and can flow out of fluid coupling element 135 at the end of tube 105. Similarly, fluid can be introduced or flow into fluid coupling element 135 at the end of tube 103 and can flow out of fluid coupling element 135 at the end of tube 104. More than one heating tube assembly 100 can be coupled in series by connecting the external ends of two fluid coupling elements 135 together with external couplers (not shown). Each fluid coupling element 135 has an opening 140 formed therein for the insertion of a flow and/or heat sensor.

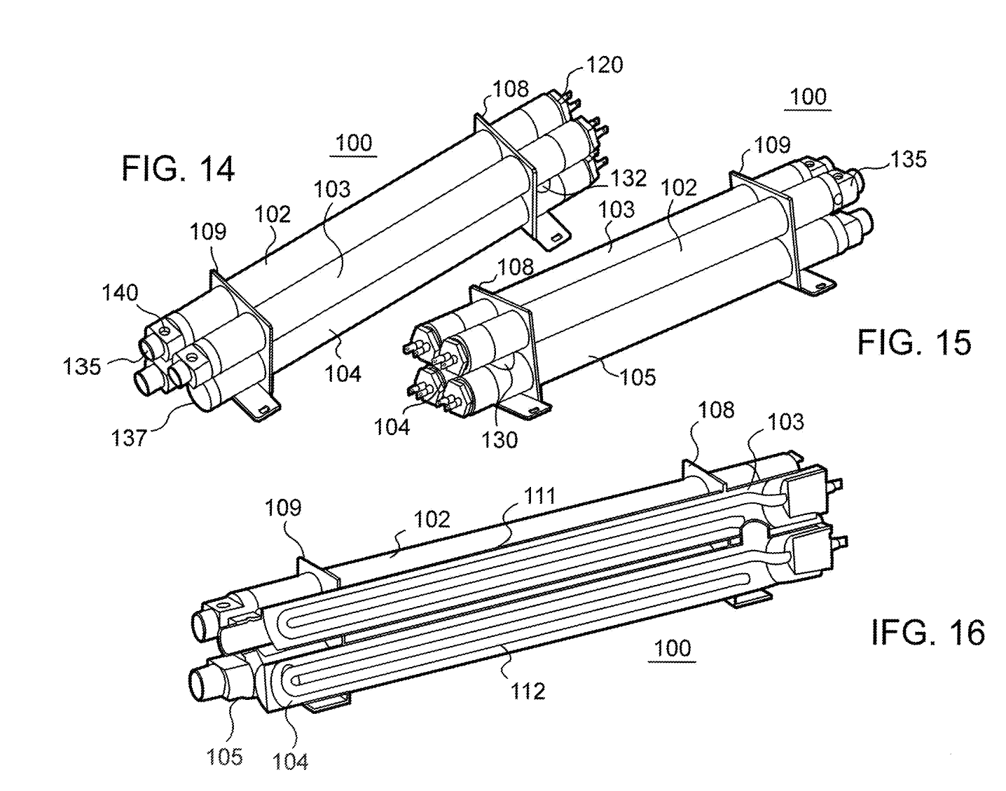

As disclosed in U.S. Pat. No. 7,046,922, entitled MODULAR TANKLESS WATER HEATER, issued 16 May 2006, and previously incorporated herein by reference, a flush valve 90 (see FIGS. 1 and 2) can be coupled to the heating system such as to one of heating tubes 16-19 at a lower end thereof or, for example, to replace sealing element 137 illustrated in FIG. 14. Valve 90 can be manually operated or include a solenoid or similar device for automatic operation. CPU 52 can include a flush program to generate a signal upon the lapse of selected period. The period can be entered by a user and can be calculated by time of usage, such as, for example, ninety days, or a period based on fluid throughput, such as, for example, 50,000 gallons have passed through the system. Once the end of the period has been reached, a message or signal indicating a flush of the system is due is generated. In a manual flush system, the message is displayed on user interface 53. Valve 90 is then opened for a desire period of time to flush the system. In an automatic system, when the period expires, CPU 52 generates a signal to open flush valve 90 for a set period of time (a solenoid or similar device is provided for automatic operation). After the flush period, flush valve 90 is closed and the system reverts to normal operation.

Referring back to FIG. 2, in addition to the above described devices and structure, the present water heater system includes an integrated snap action switch interlock device that is located in the microcontroller bracket. This switch is depressed by the insertion of a cover fastening screw that is fastened to secure the cover to the chassis. When inserted and tightened, this fastener detents the interlock switch allowing the mechanical relays to close and energize. If the safety interlock switch is opened by the removal of the fastener, the mechanical relays are disabled from closing (both legs of power) and thus the unit cannot energize the heating elements, or the circuits leading to the elements.

Thus, a new and improved tankless water heater controller is disclosed that heats water very accurately and efficiently as it is needed. Since only the amount of water needed is heated and since the temperature is closely controlled, the system is very efficient. Further, a plurality of safety features are incorporated to ensure safe operation as well as safe use of the water. The new and improved control circuitry for tankless water heaters more closely controls the temperature of the water during usage. Also, the new and improved control circuitry for tankless water heaters more closely provides a desired amount of water at a desired temperature. It will be understood, also, that an insulating blanket may be used to cover the unit to increase efficiency.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. Modular tankless water heater apparatus for use in a system including a water supply conduit and a hot water conduit, the apparatus comprising:
a heating tube assembly including a plurality of elongated tubes positioned in parallel juxtaposition, the plurality of elongated tubes being fluid connected adjacent ends thereof into a series connected configuration to form a continuous fluid passage through each tube of the plurality of tubes in turn, the continuous fluid passage being adapted to be fluid coupled between the water supply conduit and the hot water conduit of the system;
a plurality of elongated heating elements one each enclosed within an associated one of the tubes of the plurality of tubes and extending substantially from one end to another and of the enclosing tube, each of the heating elements including an electrical connector with a switching device; and
a programmable electrical power controller connected to the switching devices of the plurality of heating elements and to flow sensor and heat sensor apparatus positioned in the continuous fluid passage, the controller being programmed to activate the switching devices one at a time in response to a demand signal from the flow sensor and heat sensor apparatus.

2. Modular tankless water heater apparatus as claimed in claim 1 wherein each of the plurality of elongated tubes is a stainless steel tube.

3. Modular tankless water heater apparatus as claimed in claim 2 wherein each of the switching devices associated with each of the plurality of elongated heating elements includes a solid state relay switch.

4. Modular tankless water heater apparatus as claimed in claim 3 further including a heat sink mounted adjacent an end of a tube of the plurality of tubes closest to the water supply conduit and the solid state relay switches are mounted in heat exchanging position on the heat sink.

5. Modular tankless water heater apparatus as claimed in claim 1 wherein the programmable electrical power controller is programmed to perform a heating element test during the activation of the electrical controls for providing detailed information about each of the electrical controls and each associated heating element of the plurality of elongated heating elements.

6. Modular tankless water heater apparatus as claimed in claim 1 wherein the programmable electrical power controller is programmed with a startup delay, the programmable electrical power controller being programmed to prevent the activation of any of the electrical controls when water is drawn for a time period less than the startup delay.

7. Modular tankless water heater apparatus as claimed in claim 6 wherein the startup delay is in a range of 1 to 30 seconds.

8. Modular tankless water heater apparatus as claimed in claim 6 wherein the programmable electrical power controller is further programmed with a reset time.

9. Modular tankless water heater apparatus as claimed in claim 8 wherein the reset time is in a range of zero to thirty minutes.

10. Modular tankless water heater apparatus as claimed in claim 1 further including a latching solenoid forming a fluid coupling between the heating tube assembly, the water supply conduit and the hot water conduit of the system, the latching solenoid being constructed with two states and further constructed to remain in either of the two states without using electrical power.

11. Modular tankless water heater apparatus as claimed in claim 10 further including a leak detector, the leak detector being electrically coupled to the latching solenoid to activate the latching solenoid into one of the two states to interrupt the fluid coupling between the heating tube assembly and the water supply conduit.

12. Modular tankless water heater apparatus as claimed in claim 1 wherein the electrical connector of each of the plurality of elongated heating elements is positioned in one end of the enclosing tube with external electrical contacts and with the elongated heating element including at least one rod-shaped electrical resistance heating element extending into the enclosing tube.

13. Modular tankless water heater apparatus as claimed in claim 12 wherein the elongated heating element includes a plurality of rod-shaped electrical resistance heating elements positioned in parallel juxtaposition in a folded orientation and electrically connected in series.

14. Modular tankless water heater apparatus for use in a system including a water supply conduit and a hot water conduit, the apparatus comprising:
a heating tube assembly including a plurality of elongated stainless steel tubes positioned in parallel juxtaposition, the plurality of elongated tubes being fluid connected adjacent ends thereof into a series connected configuration to form a continuous fluid passage through each tube of the plurality of tubes in turn, the continuous fluid passage being adapted to be fluid coupled between the water supply conduit and the hot water conduit of the system, and the fluid coupling between the water supply coupling and the continuous fluid passage defining a cold water end of the continuous fluid passage;
a plurality of elongated heating elements one each enclosed within each of the tubes of the plurality of tubes and extending substantially from one end to another of the enclosing tube, each of the heating elements including an electrical connector and an associated switching device;
a heat sink thermally attached to the cold water end of the continuous fluid passage and having the switching devices mounted in heat exchanging position thereon; and
a programmable electrical power controller connected to the electrical controls of the plurality of heating elements and to flow sensor and heat sensor apparatus positioned in the continuous fluid passage, the controller being programmed to activate the electrical controls one at a time in response to a demand signal from the flow sensor and heat sensor apparatus.

15. Modular tankless water heater apparatus as claimed in claim 14 wherein the electrical connector of each of the plurality of elongated heating elements is positioned in one end of the enclosing tube with external electrical contacts and with the elongated heating element including at least one rod-shaped electrical resistance heating element extending into the enclosing tube.

16. Modular tankless water heater apparatus as claimed in claim 15 wherein the elongated heating element includes a plurality of rod-shaped electrical resistance heating element positioned in parallel juxtaposition in a folded orientation and electrically connected in series.

17. Modular tankless water heater apparatus for use in a system including a water supply conduit and a hot water conduit, the apparatus comprising:
a heating tube assembly including a plurality of elongated tubes positioned in parallel juxtaposition, the plurality of elongated tubes being fluid connected adjacent ends thereof into a series connected configuration to form a continuous fluid passage through each tube of the plurality of tubes in turn, the continuous fluid passage being adapted to be fluid coupled between the water supply conduit and the hot water conduit of the system;
a plurality of elongated heating elements one each enclosed within each of the tubes of the plurality of tubes and extending substantially from one end to another of the enclosing tube, each of the heating elements including an electrical connector with a switching device;
a programmable electrical power controller connected to the switching devices of the plurality of heating elements and to flow sensor and heat sensor apparatus positioned in the continuous fluid passage, the controller being programmed to activate the electrical controls one at a time in response to a demand signal from the flow sensor and heat sensor apparatus; and
the programmable electrical power controller being programmed with a startup delay, the startup delay preventing the activation of any of the switching devices when water is drawn for a time period less than the startup delay.

18. Modular tankless water heater apparatus as claimed in claim 17 wherein the startup delay is in a range of 1 to 30 seconds.

19. Modular tankless water heater apparatus as claimed in claim 18 wherein the programmable electrical power controller is further programmed with a reset time.

20. Modular tankless water heater apparatus as claimed in claim 19 wherein the reset time is in a range of zero to thirty minutes.
